(19) United States
(12) Patent Application Publication
(10) Pub. No.: US 2026/0059192 A1
(43) Pub. Date: Feb. 26, 2026

(54) SYSTEM AND METHOD FOR SIMULATION OF MOBILE CAMERA PHOTOGRAPHING, AND RECORDING MEDIUM IN WHICH COMPUTER-READABLE PROGRAM FOR EXECUTING SAME METHOD IS RECORDED

(71) Applicant: KOREA INSTITUTE OF CIVIL ENGINEERING AND BUILDING TECHNOLOGY, Goyang-si (KR)

(72) Inventors: Chul Hee LEE, Incheon (KR); Dong Gyou KIM, Goyang-si (KR)

(21) Appl. No.: 19/131,580

(22) PCT Filed: Nov. 27, 2023
(86) PCT No.: PCT/KR2023/019198

§ 371 Date: May 21, 2025

(30) Foreign Application Priority Data
Nov. 25, 2022 (KR) 10-2022-0160143

(51) Int. Cl. H04N 23/60; G01N 21/88; H04N 23/56; H04N 23/61; H04N 23/71; H04N 23/74

(52) U.S. Cl. CPC H04N 23/64; G01N 21/8803; H04N 23/56; H04N 23/61; H04N 23/71; H04N 23/74

(57) ABSTRACT

Disclosed are a system and a method for simulation of mobile camera photographing, and a recording medium in which a computer-readable program for executing the method is recorded. The system for simulation of mobile camera photographing comprises an image acquisition unit, a panel information input unit, an image acquisition unit information input unit, and an image information calculation unit. The image acquisition unit acquires an image of a panel moving in a preconfigured direction and speed, the panel information input unit receives an input of operation information of the panel, the image acquisition unit information input unit receives an input of configuration information of the input acquisition unit, and the image information calculation unit calculates image feature information corresponding to the operation information of the panel and the configuration information of the image acquisition unit. By this configuration, a simulated photographing environment reflecting various field conditions is created and thus image quality experiments using various types of cameras are possible.

### TECHNICAL FIELD

The present invention relates to a technology related to non-contact mobile condition inspection, and more particularly, to a system and method, which enable simulation of photographing of a mobile camera.

### BACKGROUND ART

Non-contact mobile condition inspection equipment for underground tunnels using cameras is a device that photographs a subject at a target driving speed of 80 km/h to inspect damage states through an image. However, there is a limitation in which quality of the image is not constant depending on on-site conditions of each tunnel (lighting, dust, obstacles (tiles, wires, etc.), and thus, optimization or quality analysis standards are required.

To establish the analysis standards for image quality of each tunnel site, a high-speed rotating panel device capable of photographing an indoor space at a high speed is required to compare an image acquired at each tunnel site with an image obtained by photographing the indoor space at the high speed by using the image photographed under the standard indoor environments (without any distractions).

Variables in photographing images of the tunnel include a shutter speed, an ISO, an fps, a lens aperture, and resolution for a camera, and external factors such as lighting brightness, light reflection, tunnel curvature area, a driving speed, dust, and humidity are very diverse. Various experiments are required to optimize development equipment, but it is difficult to conduct the experiments so as to optimize the equipment in actual tunnel sites.

### DISCLOSURE OF THE INVENTION

### Technical Problem

The present invention has been made to solve the above-described conventional problems, and an object of the present invention is to provide a system and method that enable image quality experiments using various types of cameras by creating a simulated photographing environment that reflects various field conditions for analysis standards on image quality of each tunnel site.

### Technical Solution

A system for simulation of mobile camera photographing according to the present invention for achieving the above object includes an image acquisition unit, a panel information input unit, an image acquisition unit information input unit, and an image information calculation unit. The image acquisition unit may acquire an image of a panel moving in a preset direction at a preset speed, the panel information input unit may receive operation information of the panel, the image acquisition unit information input unit may receive setting information of the image acquisition unit, and the image information calculation unit may calculate image feature information corresponding to the operation information of the panel and the setting information of the image acquisition unit.

According to this configuration, simulated photographing environments reflecting various field conditions may be created to implement image quality experiments using various types of cameras.

Here, the panel may rotate by a motor to move.

In addition, the system may further include a lighting information input unit configured to receive illuminance information of lighting that illuminates the panel. According to this configuration, an influence of the lighting may be better reflected in determination of quality of the image.

In addition, the system may further include a control unit comprising a panel control unit configured to control a height of the panel and a degree of tilting of the panel. According to this configuration, simulation conditions that are in consideration of a curvature radius of a tunnel by using up/down/left/right tilt movements of the panel.

In addition, the control unit may include: an image acquisition unit control unit configured to control the setting of the image acquisition unit; and a lighting control unit configured to control setting of the lighting. According to this configuration, setting of the camera or the lighting may be changed to acquire images having more various qualities.

In addition, a chart for analyzing a crack width size in the image may be attached to the panel, and a chart for analyzing clarity of the image may be attached to the panel. According to this configuration, a motion blur of the image, which may occur during high-speed movement and sensitivity depending on the lighting may be analyzed.

In addition, the system may further include a panel unit comprising the panel.

In addition, the system may further include a setting information calculation unit configured to calculate the operation information of the panel corresponding to preset image features and the setting information of the image acquisition unit. According to this configuration, an image optimized for the field conditions may be acquired, and an image for learning an artificial intelligence that reflects future image quality standards may be collected.

Furthermore, an invention embodying the system in the form of a method and a recording medium that records a computer-readable program for executing the method are disclosed together.

### Advantageous Effects

According to the present invention, the simulated photographing environment that reflects the various field conditions may be created to enable the image quality experiments using various types of cameras.

In addition, the influence of the lighting may be further reflected in determination of the image quality.

In addition, the simulation conditions that are in consideration of the curvature radius of the tunnel by using the up/down/left/right tilt movements of the panel.

In addition, the setting of the camera or the lighting may be changed to acquire the images having the more various qualities.

In addition, the motion blur of the image, which may occur during the high-speed movement and the sensitivity depending on the lighting may be analyzed.

In addition, the image optimized for the field conditions may be acquired, and the image for learning the artificial intelligence that reflects the future image quality standards may be collected.

### BRIEF DESCRIPTION OF THE DRAWINGS

FIG. 1 is a schematic block diagram of a system for simulation of mobile camera photographing according to a preferred embodiment of the present invention.

FIG. 2 is a view illustrating a use status of a panel unit.

FIG. 3 is a view illustrating a rotating panel device of a panel unit on which a lighting sensor is installed.

FIG. 4 is a view for explaining a height adjustment operation of a panel.

FIG. 5 is a view for explaining a left and right tilt adjustment operation of the panel.

FIG. 6 is a view for explaining an up and down tilt adjustment operation of the panel.

FIG. 7 is a view illustrating a configuration of control software of a control unit.

### MODE FOR CARRYING OUT THE INVENTION

Hereinafter, preferred embodiments of the present invention will be described in with reference to the accompanying drawings.

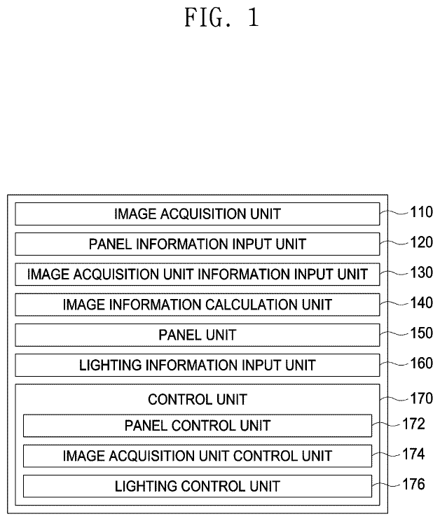

FIG. 1 is a schematic block diagram of a system for simulation of mobile camera photographing according to a preferred embodiment of the present invention. In FIG. 1, a system for simulation of mobile camera photographing includes an image acquisition unit 110, a panel information input unit 120, an image acquisition unit information input unit 130, an image information generation unit 140, a panel unit 150, a lighting information input unit 160, and a control unit 170, and the control unit 170 further includes a panel control unit 172, an image acquisition unit control unit 174, and a lighting control unit 176.

The image acquisition unit 110 acquires an image of a panel moving in a preset direction at a preset speed. For this, the panel unit 150 may include a panel, and the panel may rotate by a motor.

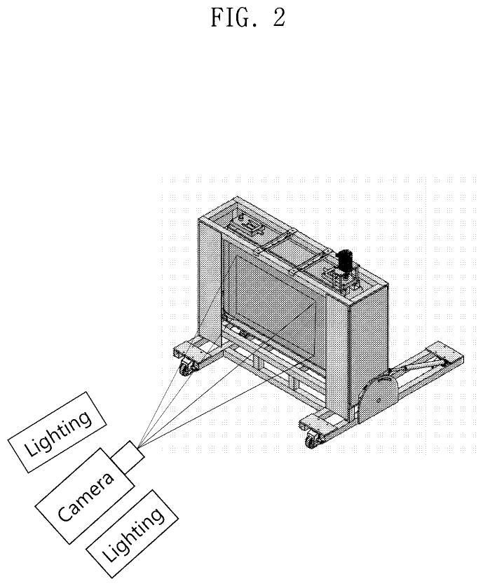

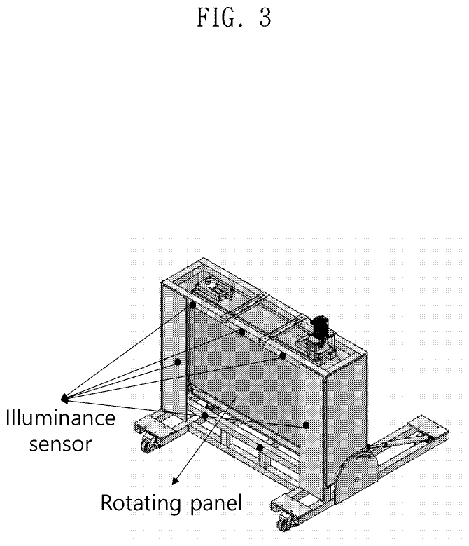

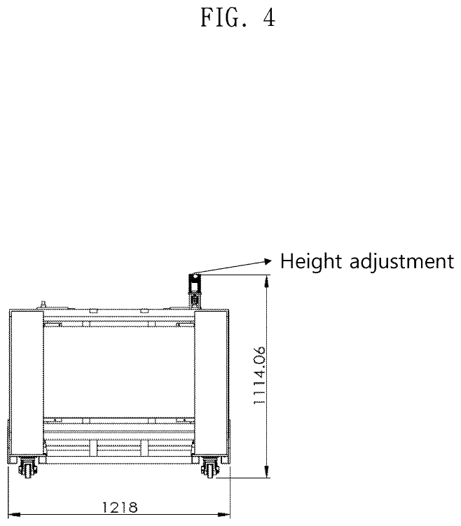

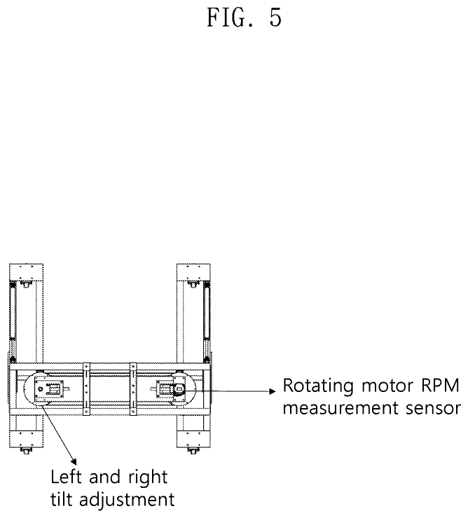

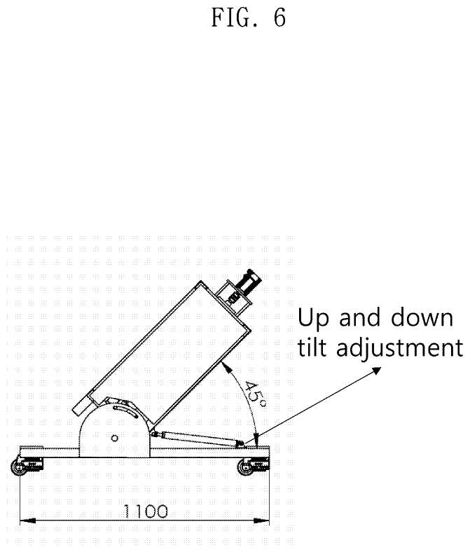

FIG. 2 is a view illustrating a use status of a panel unit, FIG. 3 is a view illustrating a rotating panel device of a panel unit on which a lighting sensor is installed, FIG. 4 is a view for explaining a height adjustment operation of a panel, FIG. 5 is a view for explaining a left and right tilt adjustment operation of the panel, and FIG. 6 is a view for explaining an up and down tilt adjustment operation of the panel.

More specifically, the panel unit 150 may be provided with a motor capable of a maximum rotation speed of 100 km/h, and validity of the rotation speed may be verified by measuring an RPM of the motor. In addition, a speed change function of 10 km/h may be provided to analyze synchronization, and optimization of a shutter speed and fps of a camera.

In addition, distortion of the image may be analyzed by tilting the panel upward and downward, and to left and right sides in consideration of a radius of curvature of the tunnel, and a sensor that is capable of measuring sensitivity of light in Lux values may be installed at each edge and upper and lower ends of a center of the panel to analyze an influence of light, and also, software that is capable of electronically controlling the rotation speed (motor RPM), the speed change, and the light sensitivity change may be mounted so as to be performed simultaneously with an camera operation.

Thus, image quality experiments using various types of Cameras are possible by creating a simulated rotating panel and indoor environments, which reflect various field conditions.

The panel information input unit 120 receives operation information of the panel, the image acquisition unit information input unit 130 receives setting information of the image acquisition unit 110, and the image information calculation unit 140 calculates feature information of an image corresponding to the operation information of the panel and the setting information of the image acquisition unit 110.

The lighting information input unit 160 receives illuminance information of the lighting illuminating the panel. According to this configuration, the influence of the lighting may be better reflected in determination of the quality of the image.

The panel control unit 172 controls a height of the panel and a degree of tilting of the panel. According to this configuration, the simulation conditions that are in consideration of the curvature radius of the tunnel by using the up/down/left/right tilt movements of the panel.

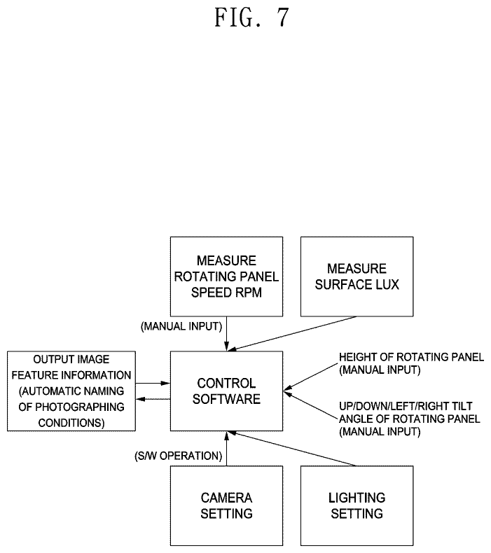

The image acquisition unit control unit 174 controls the setting of the image acquisition unit 110, and the lighting control unit 176 controls the setting of the lighting. According to this configuration, the setting of the camera or the lighting may be changed to acquire the images having the more various qualities. FIG. 7 is a view illustrating a configuration of control software of the control unit.

In addition, a chart for analyzing a crack width size in the image may be attached to the panel, and also, a chart for analyzing clarity of the image may be attached to the panel. According to this configuration, a motion blur of the image, which may occur during high-speed movement and the sensitivity depending on the lighting may be analyzed.

More specifically, the crack width size chart or the ISO standard clarity analysis chart may be attached to analyze the motion blur of the image that may occur during the high-speed movement, the sensitivity to the lighting (linked to the shutter speed of the camera), etc.

The setting information calculation unit 180 calculates operation information of the panel corresponding to the preset image features and the setting information of the image acquisition unit 110. According to this configuration, the image optimized for the field conditions may be acquired, and an image for learning an artificial intelligence that reflects future image quality standards may be collected.

More specifically, the optimization experiments between the rotation speed, the camera shutter speed, the frames per second (FPS), the lighting, etc. may be conducted and may be compared with the image quality at the site to collect the image for the artificial intelligence learning that reflects the future image quality standards.

Although the present invention has been described by the preferred some embodiments, the scope of the present invention should not be limited thereby, but should extend to modifications and improvements of the foregoing embodiments as supported by the scope of the claims.

1. A system for simulation of mobile camera photographing, the system comprising:
an image acquisition unit configured to acquire an image of a panel moving in a preset direction at a preset speed;
a panel information input unit configured to receive operation information of the panel;
an image acquisition unit information input unit configured to receive setting information of the image acquisition unit; and
an image information calculation unit configured to calculate image feature information corresponding to the operation information of the panel and the setting information of the image acquisition unit.

2. The system of claim 1, wherein the panel rotates by a motor to move.

3. The system of claim 2, further comprising a lighting information input unit configured to receive illuminance information of lighting that illuminates the panel.

4. The system of claim 3, further comprising a control unit comprising a panel control unit configured to control a height of the panel and a degree of tilting of the panel.

5. The system of claim 4, wherein the control unit comprises:
an image acquisition unit control unit configured to control the setting of the image acquisition unit; and
a lighting control unit configured to control setting of the lighting.

6. The system of claim 5, wherein a chart for analyzing a crack width size in the image is attached to the panel.

7. The system of claim 6, wherein a chart for analyzing clarity of the image is attached to the panel.

8. The system of claim 6, further comprising a panel unit comprising the panel.

9. The system of claim 8, further comprising a setting information calculation unit configured to calculate the operation information of the panel corresponding to preset image features and the setting information of the image acquisition unit.

10. A method for simulation of mobile camera photographing, which is performed by a system for simulation of mobile camera photographing, the method comprising:
an image acquisition process of acquiring an image of a panel moving in a preset direction and speed through an image acquisition unit;
a panel information input process of receiving operation information of the panel through a panel information input unit;
an image acquisition unit information input process of receiving setting information of the image acquisition unit through an image acquisition unit information input unit; and
an image information calculation process of calculating image feature information corresponding to the operation information of the panel and the setting information of the image acquisition unit through an image information calculation unit.

11. The method of claim 10, wherein the panel rotates by a motor to move.

12. The method of claim 11, further comprising a lighting information input process of receiving illuminance information of lighting that illuminates the panel.

13. The method of claim 12, further comprising a control process comprising a panel control process of controlling a height of the panel and a degree of tilting of the panel.

14. The method of claim 13, wherein the control process comprises:
an image acquisition unit control process of controlling the setting of the image acquisition unit; and
a lighting control process of controlling setting of the lighting.

15. The method of claim 14, wherein a chart for analyzing a crack width size in the image is attached to the panel.

16. The method of claim 15, wherein a chart for analyzing clarity of the image is attached to the panel.

17. The method of claim 15, further comprising a setting information calculation process of calculating the operation information of the panel corresponding to preset image features and the setting information of the image acquisition unit.

18. A recording medium in which a computer-readable program for executing the method of claim 10 is recorded.

19. The method of claim 16, further comprising a setting information calculation process of calculating the operation information of the panel corresponding to preset image features and the setting information of the image acquisition unit.
